(19) United States
(12) Patent Application Publication
(10) Pub. No.: US 2004/0020695 A1
(43) Pub. Date: Feb. 5, 2004

(54) Apparatus and a method for determining hybrid-electric vehicle performance

(75) Inventor: James Clifton Potter, Novi, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: Ford Motor Company, Dearborn, MI (US)

(21) Appl. No.: 10/064,659

(22) Filed: Aug. 5, 2002

(51) Int. Cl. B60K 1/00

(52) U.S. Cl. 180/65.1

(57) ABSTRACT

A method and apparatus for determining the performance of a hybrid electric vehicle 10. The hybrid electric vehicle 10 includes a performance prediction and display assembly 12 which comprises a controller 16, speed sensors 20, and a display 22. Particularly, controller 16 calculates the maximum sustainable speed of the vehicle 10 and the calculated maximum sustainable speed and the current vehicular speed are continually calculated/determined, communicated to the display portion 22, and displayed upon the display portion 22, as the hybrid electric vehicle 10 is being operated.

### BACKGROUND OF INVENTION

1. Field of the Invention

The present invention generally relates to a method and an apparatus for determining and displaying at least one performance parameter of a hybrid electric vehicle and more particularly, to a method and apparatus for determining the current maximum sustainable speed of the hybrid electric vehicle and displaying this speed or performance parameter to the vehicle driver, effective to provide an intuitive description of the vehicle's potential performance capabilities.

2. Background of the Invention

A hybrid electric vehicle typically includes at least two sources of torque which are alternatively or simultaneously used to power or operate the vehicle. The respectively generated torque energy is communicated to the wheels of the vehicle, effective to allow the hybrid vehicle to be operated. Typically, the first source of torque comprises an internal combustion engine which utilizes hydrocarbon type fuel to provide the desired power. The second source of torque usually includes an energy source, such as an electric battery, in combination with at least one motor and/or a motor/generator assembly. The battery is selectively and periodically “recharged” by the operating internal combustion engine in cooperative combination with the at least one motor or the motor/generator assembly in order to ensure the continued availability of energy from the energy source. Particularly, the electric battery desirably reduces the use of hydrocarbon fuel and allows for a desired reduction in the various undesirable by-products produced by the use of the hydrocarbon type fuel.

Hence, in a hybrid electric vehicle, the power needed to propel the vehicle is typically provided by the internal combustion engine and by a battery/motor system.

While it is desirable to utilize the battery, the amount of electrical charge residing within the battery limits the amount of time or the duration over which the motor may supply power to allow the vehicle to be propelled. During sustained vehicular operation (i.e., operating the vehicle on a continually varying grade, operating the vehicle at high speed, or operating the vehicle under higher than normal loading conditions), the ability of the battery to continue to supply the power or energy required to operate the motor or motor/generator assembly will diminish. At the same time, the operator will expect the vehicle to perform as a conventional vehicle, providing repeatable performance so that maneuvers, such as passing another vehicle, may be performed with confidence and in a “recognized” manner. It is therefore desirable to provide to the operator of a hybrid electric vehicle the current potential performance capabilities, attributes, or parameters of the vehicle (e.g., measures of the available performance capabilities of a vehicle) in order to assist the operator in deciding whether a certain vehicle maneuver should be attempted, has a relatively high likelihood of success, or is possible.

Current methodologies and strategies which attempt to ascertain and display a “level” of hybrid vehicle performance to the operator include the determination and display (using a light or selectively generated signal) of discrete performance modes (e.g., a “high” performance or, a “low” performance mode), which the operator then uses to determine if a maneuver is executable.

These current strategies and methodologies have several drawbacks. For example and without limitation, using only a certain number of discrete modes to visually represent estimated vehicle performance or capability requires the operator to decide whether the vehicle is capable of executing a desired maneuver using only the limited knowledge provided by the discrete mode (e.g., that the vehicle is in “high performance” mode). For example, while a discrete mode display may indicate that the vehicle is in “high performance” mode thereby indicating to an operator that the vehicle is capable of passing another vehicle, it does not indicate or communicate information related to how quickly the other vehicle may be passed. Hence, the use of these discrete modes requires the driver or operator of the vehicle to estimate the actual performance of the vehicle within each of these modes. Additionally, the performance of a hybrid vehicle changes or fluctuates during actual operation. Providing only discrete modes (e.g., high or low performance modes) does not indicate the manner in which the hybrid vehicle's performance parameters or capabilities are declining or changing over discrete intervals of time. Therefore, an operator, executing a maneuver, may suddenly discover that such a maneuver is not possible to be accomplished in the desired manner due to a sudden change in the operational mode which could have been predicted, by the driver, had the driver been given the knowledge of the manner in which one or more of the performance parameters had been changing prior to the initiation of the maneuver.

There may therefore be a need for a method and apparatus for determining and displaying the performance capabilities or performance attributes of a hybrid electric vehicle which overcomes at least some of the previously delineated drawbacks of prior techniques and strategies.

### SUMMARY OF INVENTION

In accordance with a first aspect of the present invention, an apparatus is provided for determining and displaying the performance parameters, attributes, and/or performance capabilities of a hybrid electric vehicle in a manner which overcomes at least some of the previously delineated drawbacks of prior strategies, techniques, and methodologies. Preferably the apparatus ascertains the value of a vehicle attribute in order to determine the likelihood of completing a maneuver.

In a related aspect of the present invention, a method is provided for determining and displaying the maximum sustainable speed of a hybrid electrical vehicle in a manner which overcomes some or all of the previously delineated drawbacks of prior vehicular performance strategies and methodologies. Particularly the method includes the steps of determining a maximum sustainable speed; displaying the maximum sustainable speed; and using the maximum sustainable speed to determine whether to cause the vehicle to perform a certain maneuver.

A vehicle is also provided and includes an apparatus for determining and displaying the maximum sustainable speed of said vehicle.

These and other features and advantages of the present invention will become apparent from a reading of the following detailed description of the preferred embodiment of the invention and by reference to the following drawings.

### BRIEF DESCRIPTION OF DRAWINGS

FIG. 1 is a block diagram of a performance prediction and display assembly which is made in accordance with the teachings of the preferred embodiment of the invention and which is operatively deployed within a hybrid electric vehicle.

FIG. 2 is a flowchart which includes the various steps associated with the methodology of the preferred embodiment of the invention.

### DETAILED DESCRIPTION

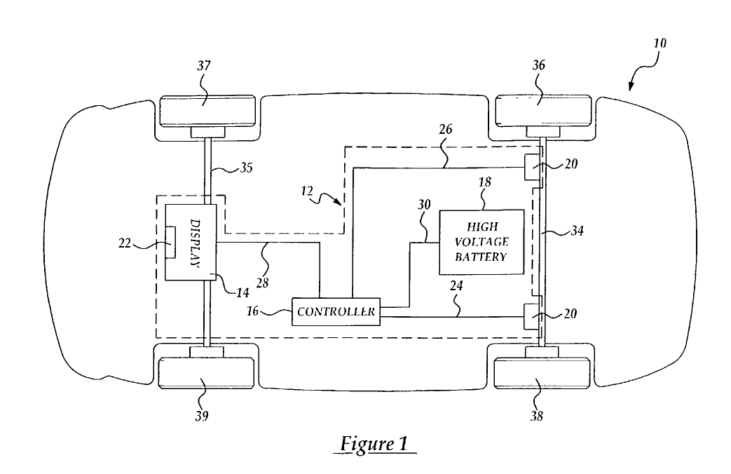

Referring now to FIG. 1, there is shown a hybrid electric vehicle 10 having a vehicular performance determination or prediction and display assembly 12 which is made in accordance with the teachings of the preferred embodiment of the invention.

At the outset, it should be appreciated that only the relevant portions of the hybrid electric vehicle 10 are shown in FIG. 1 and that the principles of the present invention are not limited to a particular type of vehicular configuration such as that which is shown in FIG. 1. Further, it should be realized that assembly 12 may be retrofittably placed and operatively utilized within an existing vehicle 10, including but not limited to a hybrid electric vehicle.

Particularly, the hybrid electric vehicle includes a controller 16, which is operable under stored program control, an energy storage assembly or high voltage battery 18, a driver display portion 14 including an alphanumeric display portion 22, a pair of sensors 20, a rear axle 34, tire and wheel assemblies 36, 38 which are mounted upon the rear axle 34, a front axle 35, and tire and wheel assemblies 37, 39 which are mounted upon the front axle 35. The sensors 20 are each mounted upon or in close proximity to the axle 34 and respectively and operatively reside in close proximity to a unique one of the wheels 36, 38. Moreover, the controller 16 is coupled to the display portion 14 by the use of bus 28, the controller 16 is coupled to the high voltage battery 18 by the use of bus 30, and the controller 16 is coupled to the sensors 20 by the respective use of busses 24, 26.

According to the teachings of the preferred embodiment of the invention, controller 16 dynamically and continually calculates the derivative of the loads which act upon the hybrid electric vehicle 10 and uses these calculations to continually (e.g., as the hybrid electric vehicle 10 is being operated) determine and display the maximum sustainable speed of the vehicle 10, in a manner which is more fully set forth below. Particularly, there are about four loads which collectively and substantially form or comprise the total forces acting against the hybrid electric vehicle 10. These forces or “loads” are as follows: the forces due to rolling resistance between at least one of the tires of the vehicle 10 and the road surface; the force on the vehicle 10 due to aerodynamic drag; the force on the vehicle 10 due to the vehicle's inclination; and the force on the vehicle 10 due to inertia.

In order to overcome the above-mentioned forces, the hybrid electric vehicle 10 must provide a tractive force (i.e., the tractive force is a function of the available torque from the driven axle 34 and is limited by the traction of the hybrid electric vehicle 10) to counter the previously delineated resistive forces. Mathematically the tractive force is described as:

F_{Tractive}=F_{Roling}+F_{Aerodynamic}+F_{Grade}+F_{Inerta}

where the variable (“FTractive”) is the tractive force, the variable (“F rolling”) is the force due to rolling resistance of the tires of assemblies 36-39 (i.e., the friction loss between these tires of the assemblies 36-39 and the surface on which the tires of the assemblies 36-39 are traversing), the variable (“Faerodynamic”) is the aerodynamic drag force on the hybrid electric vehicle 10, the variable (“Fgrade”) is the force on the hybrid electric vehicle 10 due to the grade of the surface upon which the vehicle 10 is being driven, and the variable (“Finertia”) is the inertia force on the hybrid electric vehicle 10. Furthermore, the tractive force (“FTractive”) is proportional to the amount of the torque which is provided by the driven axle 34 divided by the effective radius of the tires of the assemblies 36, 38. More particularly, the tractive force may be mathematically described or expressed below in the form of:

$${F}_{Tractive} = \frac{{Torque}_{Axle}}{{Tire}_{Radius}}$$

Where the variable (“TorqueAxle”) is the torque supplied by the axle 34 and the variable (“TireRadius”) is the effective rolling radius of the tires of the assemblies 36, 38. The resistive forces in the tractive force equation may be mathematically calculated in the manner which is more fully set forth below.

The force to overcome rolling resistance may be defined as “Force rolling” and is expressed as follows;

Force_{Rolling}=K₁*Weight_{Vehicle} Cos(θ)

where the variable (“K₁”) equals approximately 0.010 for an average paved surface, the variable (“Weightvehicle”) is the total weight of the hybrid electric vehicle 10 measured in pounds of mass (i.e., Ibm), and the variable “Cos(θ)” is the cosine of the angle theta (i.e., the symbol for theta is “θ”) where “0” is the grade angle (i.e., the vehicle inclination angle) which is measured in radians.

The force due to aerodynamic loading may be defined as “Force Aerodynamic” and is expressed as follows;

$${Force}_{Aerodynamic} = \frac{{C}_{D} ρ {A}_{Frontal} {Speed}_{Vehicle}^{2}}{2}$$

where the variable (“C_{d}”) represents the drag coefficient for a typical passenger car and light truck and may be assigned a respective representative value from approximately 0.20 to 0.45, the variable (“ρ”) represents the density of the air, the variable (“Afrontal”) represents the frontal area of a typical passenger car and light truck (e.g., the area in front of the passenger compartment) and may be assigned a respective representative value from approximately 20 square feet to approximately 40 square feet, and the variable (“Speed² Vehicle”) represents the squared velocity of the hybrid electric vehicle 10 in ft²/sec².

The force to overcome the vehicle inclination may be expressed as follows;

Force_{Grade}=Weight_{Vehicle}*Sin(θ)

and the grade may be defined as;

Grade (%)=100%*Tan(θ)

where the variable “Tan(θ)” is the tangent of the angle theta and is measured in radians where (“θ”) has previously been defined as the grade angle (i.e., the vehicle inclination angle).

Solving the previous equation for “θ” provides the following equation:

$$θ = {Sin}^{1} ( \frac{{F}_{Grade}}{{W}_{Vehicle}} )$$

The inertia force may be expressed as follows;

$${Force}_{Inortia} = \frac{{Weight}_{Vehicle} Accel}{{g}_{c}}$$

where the variable (“Accel”) represents the acceleration of the hybrid electric vehicle 10, which is measured in feet per second squared or (ft/sec²) and the variable (“gc”) represents the substantially constant gravitational force exerted on the hybrid electric vehicle 10 which is measured in pounds mass or (lbm).

For a detailed determination of the tractive force, the inertia forces may be separately calculated or determined for translation and rotation of vehicular motion.

However, in this analysis, the foregoing “lumped parameters” have been found to be sufficient to describe the loading on the hybrid electric vehicle 10.

Combining the terms from equations provided above, one may define the required axle torque necessary to maintain a particular vehicular operating condition in the following manner:

$${Torque}_{Aisle} = [ {K}_{1} * {Weight}_{Vehicle} Cos ( θ ) + \frac{{C}_{D} ρ {A}_{Frontal} {Speed}_{Vehicle}^{2}}{{K}_{2}} + {Weight}_{Vehicle} * Sin ( θ ) + \frac{{Weight}_{Vehicle} Accel}{{g}_{c}} ] * {Tire}_{Radius} \vert$$

Wherein the weight (“WeightVehicle”), frontal area (“AFrontal”), axle torque (“TorqueAxle”), and acceleration (“Accel”) are variables. Of these variables, the frontal area and vehicle weight are respectively made equal to a “normal” or representative frontal area of the hybrid electric vehicle 10 (which has been previously defined) and the curb weight of the hybrid electric vehicle 10 may be estimated or measured. The compensation for these two variables are based on the acceleration (“Accel”) and axle torque (“TorqueAxle”), both of which are measured parameters.

Using the grade force as the dependent variable, according to the teachings of the present invention, the loading forces maybe translated into an “equivalent” or “pseudo grade” in the manner which is more set forth below.

However, the methodology which is embodied within or represented by the equation (8) may provide a false indication of loading during throttle tip-out conditions if the axle torque is based on a performance map of the engine and throttle position. That is, if an engine map is used to determine the torque of the vehicle, a false indication of loading may occur when the throttle position is quickly reduced and until the system (i.e., engine) reaches a steady state. Further, the throttle position may change very quickly and the “reading” or information taken from the engine map may therefore indicate a reading which is based on the sudden change in throttle positions. However, the vehicle loading will reduce slowly due to inertia. Therefore, the throttle position information, in the most preferred embodiment of the invention, is filtered or the readings are slowly taken during such transient events. In this case, the value of the “grade force”, which is calculated or derived at the previous or the “last” time calculation step should be “frozen” when a negative rate-of-change in throttle position occurs. The value will remain “frozen” until either the throttle has increased by a calibrateable positive offset or until a certain amount of time has elapsed (e.g., until a delay timer (not shown) has “timed-out”). As noted above, if an engine performance map is used to infer engine torque, the inferred torque will vary rapidly with a change in throttle position. Therefore, the grade information may also be filtered to provide a more accurate reading. In the most preferred embodiment of the invention, the grade force is calculated at about 100 milli-second intervals and the rate-of-change of throttle position is calculated at intervals of about 25 milli-seconds, thereby causing stable and reliable control to be achieved.

The acceleration of the hybrid electric vehicle 10 may be calculated by any number of techniques including, but not limited to, by the use of a pulse wheel (not shown) which may be physically and communicatively coupled to the controller 16 and which includes a plurality of movable teeth which are sensed or counted in order to determine the acceleration of the hybrid electric vehicle 10, or by use of the sensors 20.

One method for calculating vehicular acceleration, which may be accurately used with a digital signal, is a modification to the central difference method of acceleration determination which uses such a pulse wheel (not shown). Particularly, this method uses pulse counts from four different time steps resulting in inherent signal filtering and a stable acceleration signal. That is, the determined acceleration is based on information from the last four sensor teeth counts. Since each reading has the same weighting, a reading which is higher or lower than normal will be eliminated or “filtered out”. This modified central difference method results in the following method of acceleration determination:

$$Accel = [ \frac{{f}_{t} - {f}_{t - 1} - {f}_{t - 2} + {f}_{t - 3}}{Δ {t}^{2}} ] * \frac{{K}_{3}}{N * {Tire}_{Revs / mile}}$$

where the variable (“f”) represents the number of teeth counted on the output shaft pulse wheel, the variable (“t”) represents time, the variable (“N”) represents the number of teeth per revolution of the pulse wheel, the variable (“K3”) representing a third constant which is equal to about 5,280 ft/mile, and the variable (“TireRevs/mile”) represents the number of revolutions associated with the tires of the assemblies 36, 38 of the hybrid electric vehicle 10 over a distance of about one mile.

By using equation eight along with this relatively “stable” method of calculating vehicle acceleration, the loading on the hybrid electric vehicle 10 may be efficiently and reliably calculated without the need for adding additional sensors 20. Alternatively, such acceleration may be sensed by an acceleration sensor and provided to the controller 16.

Since it is assumed that there is no tire slip, the output of sensors 20 may be assumed to be substantially equal to the transmission output shaft speed. In this manner, sensors 20 detect or ascertain the current speed of the hybrid electric vehicle 10, as well as the total number of revolutions of the tire of the assemblies 36, 38 over one mile (i.e., the total amount of revolutions completed by the tires of the assemblies 36, 38 over the distance of one mile).

Particularly, the driver display portion 14 includes an alphanumeric display 22 which permits a driver of the hybrid electric vehicle 10 to view the current operating or traveling speed of the hybrid electric vehicle 10 (e.g., measured in miles per hour or substantially any other measuring unit, such as and without limitation in kilometers per hour) and the potential maximum sustainable speed of the hybrid electric vehicle 10 (i.e., the maximum sustainable speed of the hybrid electric vehicle 10 is measured in the same units as the aforementioned “current speed” of the hybrid electric vehicle 10) and defines a steady operating speed of the vehicle 10 which may be accomplished over some predetermined period of time (e.g., about five minutes) or which may allow the vehicle 10 to perform some predetermined maneuver. It should be understood that nothing in this description is meant to limit the driver display portion 14 to a display which displays the current speed and potential or calculated maximum sustainable speed of the hybrid electric vehicle 10 in a particular unit of measurement. Rather, the units of measurement which are used in this description are for illustrative purposes only. In order to determine the maximum sustainable speed, previous TorqueAxle equation is “re-arranged” in the following manner. As should be apparent from the foregoing, the current pseudo gradient, (0) is the only unknown variable within the following equation:

$${K}_{1} Cos ( θ ) + Sin ( θ ) = [ \frac{{Torque}_{Axle}}{{Tire}_{Radius}} - \frac{{C}_{D} {ρ}_{Air} {A}_{Frontal} {Speed}_{Vehicle}^{2}}{{K}_{2}} - \frac{{Weight}_{Vehicle} Accel}{{G}_{c}} ] * \frac{1}{{Weight}_{Vehicle}}$$

Solving for the pseudo gradient, (θ) results in four roots, of which, the positive root is used as follows;

$$θ = {Cos}^{- 1} [ \frac{( \frac{{F}_{Tractive} - {F}_{Aerodynamic} - {F}_{Inerna}}{{Weight}_{Vehicle}} ) * {K}_{1} + \sqrt{1 + {K}_{1}^{2} - {( \frac{{F}_{Tractive} - {F}_{Aerodynamic} - {F}_{Inerna}}{{Weight}_{Vehicle}} )}^{2}}}{1 + {K}_{1}^{2}} ] \vert$$

This pseudo gradient is the “equivalent gradient” that the vehicle is operating on based on the determined vehicle loading. In order to determine the maximum sustainable speed (see equation below), the TorqueAxle equation is solved for the vehicle speed using the pseudo gradient above and the torque is set to the maximum sustainable torque or “Torque_{Axle}(MAX)” of the system which defines the largest amount of torque which may be produced by the vehicle 10 over the predetermined period of time and which may be measured the previously delineated manner, such as by use of the TorqueAxle equation. Since the goal is to determine the maximum sustainable speed, the acceleration (i.e., the variable denoted “Accel”) is set to zero.

$${Speed}_{Sustainable} = \pm \sqrt{\frac{2 {G}_{c}}{{ρ}_{Air} {A}_{Frontal} {C}_{D}} \{ \frac{{Torque}_{Axle ( Max )}}{{Tire}_{Radius}} - [ {Weight}_{Vehicle} * ( {K}_{1} Cos ( θ ) + Sin ( θ ) ) ] \}} \vert$$

In operation, the controller 16 determines, by the use of a stored operational program and certain input signals supplied by the sensors 20 through busses 24, 26, both the present speed attribute of the hybrid electric vehicle 10 and the potential or calculated maximum sustainable speed attribute of the hybrid electric vehicle 10 according to the above delineated expression. Particularly, the controller 16 uses the aforementioned signals which emanate from the sensors 20 to calculate or ascertain the values of the four previously delineated loads which act against the hybrid electric vehicle 10, these four loads or forces being: the forces due to rolling resistance between the tires of the assemblies 36-39 and the road surface; the force on the vehicle due to aerodynamic drag; the force on the vehicle due to the vehicle's inclination; and the force on the vehicle due to inertia. The controller 14 then uses the values for these four loads or forces and calculates a maximum sustainable speed, and communicates this maximum sustainable speed to the driver display portion 14 through bus 28. The driver display portion 14 “posts” or displays the information on the alphanumeric display 22. Particularly, the information which is displayed or posted, in one non-limiting embodiment, comprises the current vehicular speed attribute and the potential maximum sustainable speed attribute of the hybrid electric vehicle 10. The driver of the hybrid electric vehicle 10 is then able to view and compare the current speed of the hybrid electric vehicle 10 to the potential maximum sustainable speed of the hybrid electric vehicle 10 and, in a relatively convenient manner, determine whether the hybrid electric vehicle 10 “contains” or has enough power to make a calculated pass, or substantially any other maneuver which requires an increased amount of power or speed from the hybrid electric vehicle 10.

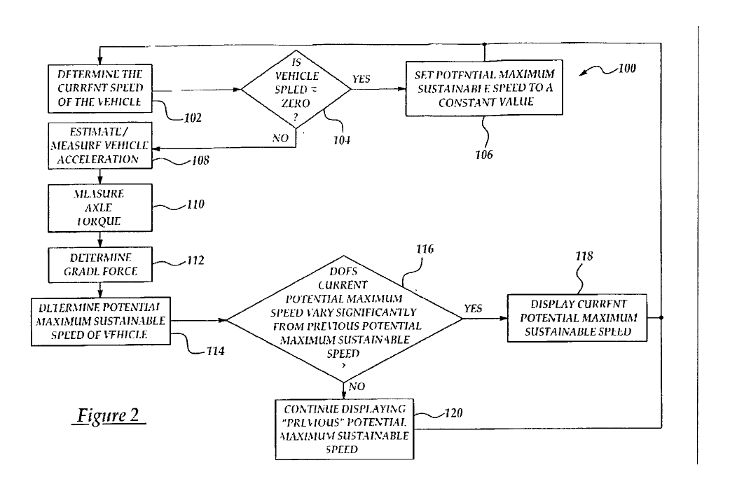

The methodology of the preferred embodiment of the invention will now be more fully discussed with respect to FIG. 2. As shown, the methodology or flowchart 100 of the preferred embodiment of the invention includes a first step 102 in which the controller 16 determines the current operating speed of the hybrid electric vehicle 10 in the previously delineated manner. When the controller 16 has determined the current speed, step 102 is followed by step 104 in which the controller 16 determines if the current operating speed of the hybrid electric vehicle 10 is approximately zero.

If the controller 16 determines that the current speed of the hybrid electric vehicle 10 is approximately zero, step 104 is followed by step 106 in which the controller 16 communicates a signal to the alphanumeric display 22 of the driver display portion 14, by the use of bus 28, which “sets” or causes the potential maximum sustainable speed of the hybrid electric vehicle 10 to a predetermined constant value. Step 106 is followed by step 102. If the controller 16 determines that the current speed of the hybrid electric vehicle 10 is not approximately zero, step 104 is followed by step 108 in which the sensors 20 will generate and communicate certain signals to the controller 16 which allow the controller 16 to measure or estimate the acceleration of the hybrid electric vehicle 10. Other acceleration computing or determination methods may be used in other non-limiting embodiment of the invention in combination with other apparatuses, such as a pulse wheel.

Step 108 is followed by step 110 in which the sensors 20 communicate certain signals to the controller 16 which allow the controller 16 to measure the axle torque.

Step 110 is followed by step 112 in which sensors 20 communicate certain signals to the controller 16 which allow the controller 16 to determine the grade force exerted upon the hybrid electric vehicle 10, in the manner delineated above. Step 114 follows step 112 and, in this step 114, the controller 16, through stored program control, determines the potential maximum available torque of the hybrid electric vehicle 10 (i.e., by using equation (8) in the previously delineated manner).

Knowing the grade force and the maximum available torque, the maximum sustainable vehicle speed is then calculated by the controller 16 by use of the previously delineated equation. The vehicle acceleration value in this case is “set to” or made equal to zero. However, it should be understood that all of the foregoing equations may be substituted in part or in whole by look-up tables embedded within the software code which is resident within controller 16.

Continuing with methodology 100, step 114 is followed by step 116 in which the controller 16 determines if the current potential maximum sustainable speed of the hybrid electric vehicle 10 varies significantly from the previously ascertained or calculated potential maximum sustainable speed. If the currently ascertained potential maximum sustainable speed of the hybrid electric vehicle 10 varies significantly from the previously ascertained or calculated potential maximum sustainable speed of the hybrid electric vehicle 10 (e.g., by about ten-percent of the previously calculated or determined maximum sustainable speed), then step 116 is followed by step 118 in which the controller communicates a certain signal to the driver display portion 14 through bus 28 which then communicates a subsequent signal to the alphanumeric display 22 to display the currently ascertained or calculated potential maximum sustainable speed of the hybrid-electric vehicle 10. Alternatively, the displayed maximum sustainable speed is continually updated as the hybrid electric vehicle 10 is operated. If the currently ascertained or calculated potential maximum sustainable speed of the hybrid electric vehicle 10 does not vary significantly from the previously calculated or determined potential maximum sustainable speed of the hybrid electric vehicle 10, then step 116 is followed by step 120 in which the controller 16 communicates a certain signal to the driver display portion 14, through bus 28, which then communicates a subsequent signal to the alphanumeric display 22 and which causes the display 22 to continue to display the previously ascertained or calculated potential maximum sustainable speed of the hybrid-electric vehicle 10. Steps 106, 118, and 120 are followed by step 102.

It is to be understood that the invention is not limited by the exact construction and methodology which has been delineated above, but that various changes and modifications may be made without departing from the spirit and the scope of the inventions as are more fully delineated in the following claims. Hence, from the foregoing it should be appreciated that the performance prediction and display assembly 12 may even be employed upon a conventional or non-hybrid vehicle. Moreover, it should be appreciated that the assembly 12 continually determines and displays the maximum sustainable vehicular speed as the hybrid electric vehicle 10 is being operated. That is, the term “continually” means that assembly 12 is operable whenever the hybrid electric vehicle 10 is operated and during such operation, the assembly 12 is adapted to determine and display the maximum sustainable speed of the hybrid electric vehicle 10. In this manner, the operator of the hybrid electric vehicle 10 will be shown the manner in which the maximum sustainable speed changes over time as well as a value which may be used by the operator to determine whether to begin a maneuver.

1. An apparatus comprising: a controller which calculates a maximum sustainable speed of a hybrid electric vehicle; and a display which is coupled to said controller and which displays said calculated maximum sustainable speed.

2. The apparatus of claim 1 wherein said controller continually calculates said maximum sustainable speed as said hybrid electric vehicle is being operated and wherein said displayed maximum sustainable speed is continually updated as said hybrid electric vehicle is being operated.

3. The apparatus of claim 1 wherein said controller calculates a second maximum sustainable speed of said hybrid electric vehicle and causes said second maximum sustainable speed to be displayed only if said second maximum sustainable speed differs from said previously calculated maximum sustainable speed by a predetermined amount.

4. The apparatus of claim 1 wherein said controller calculates said maximum sustainable speed by the use of an amount of rolling resistance between at least one tire of said hybrid electric vehicle and a surface, an amount of aerodynamic drag which is applied to said hybrid electric vehicle, an amount of inclination force which is applied to said hybrid electric vehicle, and an amount inertial force which is applied to said hybrid electric vehicle.

5. The apparatus of claim 3 wherein said amount of rolling resistance between said at least one tire of said hybrid electric vehicle and said surface is calculated by use of the weight of said vehicle.

6. The apparatus of claim 5 wherein said hybrid electric vehicle is operated at a speed and wherein said amount aerodynamic drag is calculated by the use of said speed of said hybrid electric vehicle.

7. The apparatus of claim 6 wherein said hybrid electric vehicle accelerates by a certain amount and wherein said certain amount of inertial force is calculated by the use of said certain amount of acceleration of said hybrid electric vehicle.

8. The apparatus of claim 7 further comprising a pulse wheel which is coupled to said controller and which measures said certain amount of acceleration.

9. A vehicle including an apparatus for continually determining and displaying a maximum sustainable speed of said vehicle.

10. The vehicle of claim 9, wherein said apparatus includes a controller which receives certain signals and which uses said certain signals to calculate said maximum sustainable speed of said vehicle and a display portion which is coupled to said controller and which displays said determined certain maximum sustainable speed.

11. The vehicle of claim 10 further comprising a pulse wheel which is coupled to said controller, which measures an acceleration of said vehicle, and which communicates said measured acceleration to said controller.

12. The vehicle of claim 10 wherein said vehicle is operated at a certain speed and wherein said display portion displays said certain speed.

13. The vehicle of claim 12 wherein said controller calculates a second maximum sustainable speed and causes said second maximum sustainable speed to be displayed only if said second maximum sustainable speed differs from said sustainable speed by a predetermined amount.

14. A method for operating a vehicle comprising the steps of: determining a maximum sustainable speed; and using said maximum sustainable speed to determine whether to cause said vehicle to perform a certain maneuver.

15. The method of claim 14 further comprising the steps determining whether the speed of said vehicle is greater then zero; and calculating said maximum sustainable speed only if said speed of said vehicle is greater than zero.

16. The method of claim 15 further comprising the step of displaying a predetermined value when said vehicle speed is zero.

17. The method of claim 15 wherein said step of calculating said maximum sustainable speed comprises the steps of: measuring an acceleration of said hybrid electric vehicle; measuring the torque of at least one axle of said hybrid electric vehicle; estimating a grade force; and using said torque and said estimated grade to calculate said maximum sustainable speed only if said measured acceleration is greater then zero.

18. The method of claim 17 further comprising the step of determining whether the calculated maximum sustainable speed varies from a previously calculated maximum sustainable speed by a predetermined amount.

19. The method of claim 18 further comprising the step of displaying said calculated maximum sustainable speed only if said calculated maximum sustainable speed varies from said previously displayed maximum sustainable speed by a predetermined amount.

20. The method of claim 19 wherein said predetermined amount is greater then ten percent of said previously displayed maximum sustainable speed and wherein said method further comprises the step of displaying the current speed of the vehicle.
